(19) United States
(12) Patent Application Publication
(10) Pub. No.: US 2015/0106163 A1
(43) Pub. Date: Apr. 16, 2015

(54) OBTAINING OPTIMAL PRICING STRATEGY IN A SERVICE ENGAGEMENT

(71) Applicant: Tata Consultancy Services Limited, Mumbai (IN)

(72) Inventors: Veerendra Kumar RAI, Hadapsar Pune (IN); Sanjit MEHTA, Hadapsar Pune (IN); Praveen CHANDAK, Hadapsar Pune (IN); Ashish Kumar JHA, Hadapsar Pune (IN); Abhinay PUVVALA, Hadapsar Pune (IN)

(21) Appl. No.: 14/514,603

(22) Filed: Oct. 15, 2014

(30) Foreign Application Priority Data
Oct. 15, 2013 (IN) 3240/MUM/2013

(51) Int. Cl. G06Q 30/02

(52) U.S. Cl. CPC G06Q 30/0206
USPC 705/7.35

(57) ABSTRACT

Systems and methods for obtaining an optimal pricing strategy in a service engagement are disclosed. A model is created for the service engagement between a client and vendor. For the service engagement, a pricing strategy is selected. The pricing strategy is selected from one of a fixed strategy, a variable strategy and a combination thereof. Subsequent to selecting the pricing strategy, a client payoff associated with the client and a vendor payoff associated with the vendor are computed. The model is simulated to obtain a time series data. Based on the simulation, an optimal pricing strategy is obtained by calculating an optimizer payoff function. The optimizer payoff function is calculated by assigning relative weights to the client payoff and the vendor payoff. The optimal pricing strategy is obtained by altering the pricing strategy to maximize the optimizer payoff function.

### CROSS-REFERENCE TO RELATED APPLICATIONS AND PRIORITY

The present application claims priority to Indian Patent Application No. 3240/MUM/2013, filed on Oct. 15, 2013, the entirety of which is hereby incorporated by reference.

### FIELD OF INVENTION

The present disclosure in general relates to a field of service engagement in production support services. More particularly, the present disclosure relates to systems and methods providing relational approach to pricing for the production support services.

### BACKGROUND

In most of the existing Information Technology (IT) enterprises, outsourcing engagements follow standard pricing paradigms. The pricing paradigms comprise fixed pricing, or variable pricing approaches. The pricing paradigms may be selected based on relatively standard pricing points. Generally, the pricing paradigms are selected based on tacit understanding of requirements agreed during negotiations between a client and a vendor. Further, the pricing paradigms may not be derived based on the context variables or engagement objectives. The pricing paradigms do not optimize payoffs of the vendor and/or client as per the requirements agreed during the negotiations. Further, the pricing strategies do not consider various dynamics within the production support services that could have a profound impact on final outcomes of the service engagement.

In pricing paradigm for services, interaction with customer is relational. Whereas, in manufacturing and goods paradigm, the interaction with customer is transactional. In order to obtain an optimal pricing paradigm for services, it may be prevalent to develop transaction based pricing models for the service engagement in the production support services. However, the transaction based pricing models may not be rational and optimized to meet objectives of the service engagement of the client.

### SUMMARY

This summary is provided to introduce concepts related to systems and methods for obtaining optimal pricing strategy in a service engagement and the concepts are further described below in the detailed description. This summary is not intended to identify essential features of the claimed subject matter nor is it intended for use in determining or limiting the scope of the claimed subject matter.

In one implementation, a computer implemented method for obtaining an optimal pricing strategy in a service engagement is disclosed. The method comprises creating a model for a service engagement between a client and a vendor. The model is created based on a template selected from a plurality of pre-defined templates in a production support. The template is selected based upon a structure of the service engagement comprising contextual variables and objectives associated with the model. The method further comprises selecting a pricing strategy for the service engagement based on the contextual variables and the objectives. The pricing strategy is selected from one of a fixed strategy, a variable strategy and a combination thereof. The method further comprises computing, by a processor, a vendor payoff associated with the vendor and a client payoff associated with the client, based on the pricing strategy selected for the model. The method further comprises simulating the model, by the processor, for a predefined time interval to obtain a time series data. The time series data is indicative of behaviour of the model with respect to the client payoff and the vendor payoff. The method further comprises obtaining, by the processor, an optimal pricing strategy for the client and the vendor based on the time series data. The optimal pricing strategy is obtained by calculating an optimizer payoff function. The optimizer payoff function is calculated by assigning relative weights to the client payoff and the vendor payoff. The optimal pricing strategy is obtained by altering the selection of the pricing strategy to maximize the optimizer payoff function.

In one implementation, a system for obtaining an optimal pricing strategy in a service engagement is disclosed. The system comprises a processor and a memory coupled to the processor. The processor executes program instructions stored in the memory to create a model for a service engagement between a client and a vendor. The model is created based on a template selected from a plurality of pre-defined templates. The template is selected based upon a structure of the service engagement comprising contextual variables and objectives associated with the model. The processor further executes the program instructions to select a pricing strategy for the service engagement based on the contextual variables and the objectives. The pricing strategy is selected from one of a fixed strategy, a variable strategy and a combination thereof. The processor further executes the program instructions to compute a client payoff associated with the client and a vendor payoff associated with the vendor, based on the pricing strategy selected for the model. The processor further executes the program instructions to simulate the model for a predefined time interval to obtain a time series data. The time series data is indicative of behaviour of the model with respect to the client payoff and the vendor payoff. The processor further executes the program instructions to obtain an optimal pricing strategy for the client and the vendor based on the time series data. The optimal pricing strategy is obtained by calculating an optimizer payoff function. The optimizer payoff function is calculated by assigning relative weights to the client payoff and the vendor payoff. The optimal pricing strategy is obtained by altering the selection of the pricing strategy to maximize the optimizer payoff function.

In one implementation, a non-transitory computer readable medium embodying a program executable in a computing device for obtaining an optimal pricing strategy in a service engagement is disclosed. The program comprises a program code for creating a model for a service engagement between a client and a vendor. The model is created based on a template selected from a plurality of pre-defined templates. The template is selected based upon a structure of the service engagement comprising contextual variables and objectives associated with the model. The program further comprises a program code for selecting a pricing strategy for the service engagement based on the contextual variables and the objectives. The pricing strategy is selected from one of a fixed strategy, a variable strategy and a combination thereof. The program further comprises a program code for computing a vendor payoff associated with the vendor and a client payoff associated with the client, based on the pricing strategy selected for the model. The program further comprises a program code for simulating the model for a predefined time interval to obtain a time series data. The time series data is indicative of behaviour of the model with respect to the client payoff and the vendor payoff. The program further comprises a program code for obtaining an optimal pricing strategy for the client and the vendor based on the time series data. The optimal pricing strategy is obtained by calculating an optimizer payoff function. The optimizer payoff function is calculated by assigning relative weights to the client payoff and the vendor payoff. The optimal pricing strategy is obtained by altering the selection of the pricing strategy to maximize the optimizer payoff function.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system for obtaining optimal pricing strategy in a service engagement, in accordance with an embodiment of the present disclosure.

FIG. 2 illustrates the system, in accordance with an embodiment of the present disclosure.

FIG. 3 illustrates incident response queue for the incident management, in accordance with an embodiment of the present disclosure.

FIG. 4 illustrates break even condition, in accordance with an embodiment of the present disclosure.

FIG. 5 illustrates a method for obtaining optimal pricing strategy in a service engagement, in accordance with an embodiment of the present disclosure.

### DETAILED DESCRIPTION

Systems and methods for obtaining optimal pricing strategy in a service engagement are disclosed. At first, a model is created for a service engagement between a client and a vendor. The model comprises of a set of building blocks. The set of building blocks are computed based on a capacity and the model is optimized on the basis of a context and objectives of a service engagement by a client and a vendor. The model is built to maximize payoffs of the client and vendor.

In order to obtain an optimal pricing strategy in the service engagement, a model is created based on a template selected from a plurality of pre-defined templates. The template is selected based a structure of the service engagement comprising contextual variables and objectives associated with the model. For the service engagement, a pricing strategy is selected. The pricing strategy is selected from one of a fixed strategy, a variable strategy and a combination thereof. Subsequent to selecting the pricing strategy, a client payoff associated with the client and a vendor payoff associated with the vendor are computed. After computing the vendor payoff and the client payoff, the model may be simulated. The model may be simulated to obtain a time series data indicative of behaviour of the model with respect to the client payoff and the vendor payoff.

Based on the time series data, an optimal pricing strategy for the client and the vendor may be obtained. The optimal pricing strategy may be obtained by calculating an optimizer payoff function. The optimizer payoff function may be calculated by assigning relative weights to the client payoff and the vendor payoff. The optimal pricing strategy may be altering the selection of the pricing strategy to maximize the optimizer payoff function.

While aspects of described system and method for obtaining optimal pricing strategy in a service engagement may be implemented in any number of different computing systems, environments, and/or configurations, the embodiments are described in the context of the following exemplary system.

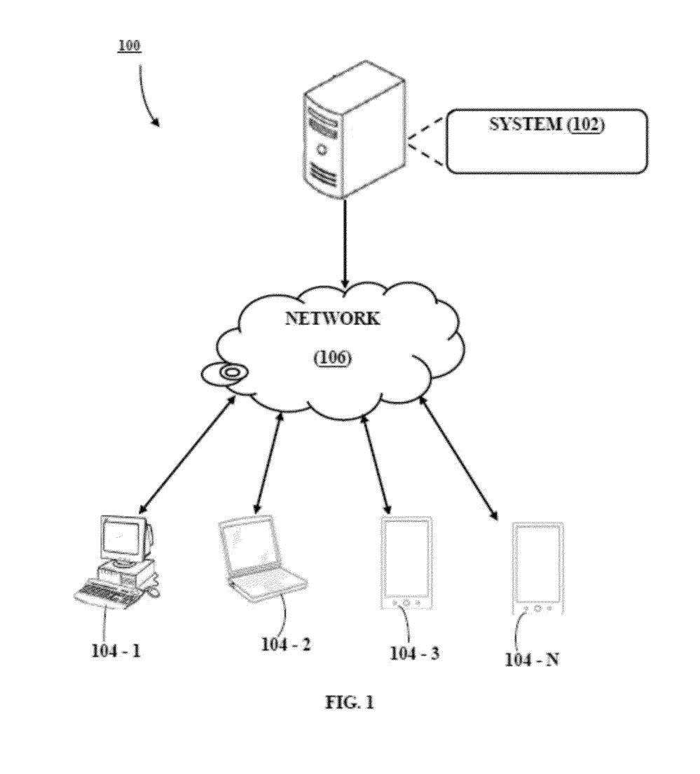

Referring now to FIG. 1, a network implementation 100 of a system 102 for obtaining optimal pricing strategy in a service engagement is illustrated, in accordance with an embodiment of the present disclosure. The system 102 may create a model for a service engagement between a client and a vendor. The model may be created based on a template selected from a plurality of pre-defined templates. The template is selected based upon a structure of the service engagement comprising contextual variables and objectives associated with the model. The system 102 may select a pricing strategy for the service engagement. The system 102 may select the pricing strategy from one of a fixed strategy, a variable strategy and a combination thereof. The system 102 may to compute a client payoff associated with the client and a vendor payoff associated with the vendor. Based on the client payoff and the vendor payoff computed, the system 102 may simulate the model for a pre-defined time interval to obtain a time series data.

After simulating the model, based on the time series data, the system 102 may obtain an optimal pricing strategy for the client and the vendor. The system 102 may calculate an optimizer payoff function to obtain the optimal pricing strategy. The system 102 may calculate the optimizer payoff function by assigning relative weights to the client payoff and the vendor payoff. In order to obtain the optimal pricing strategy, the system 102 may alter the selection of the pricing strategy to maximize the optimizer payoff function.

Although the present disclosure is explained by considering a scenario that the system 102 is implemented as an application on a server. It may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

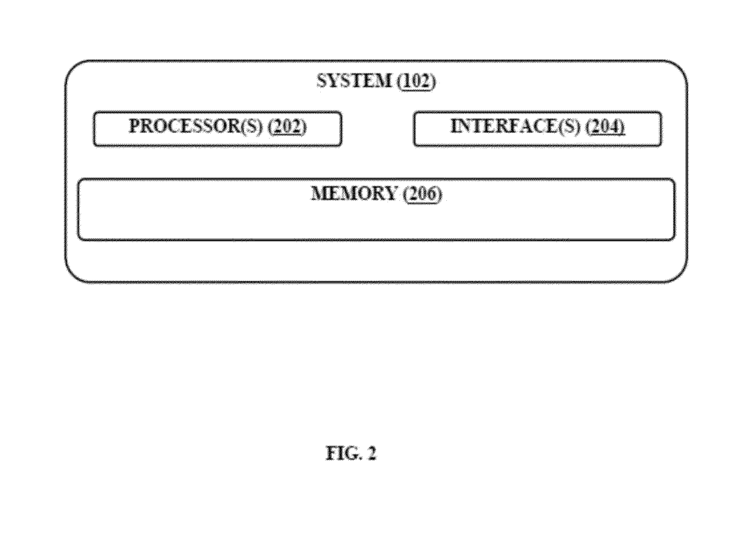

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, an Application Program Interface (API) and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

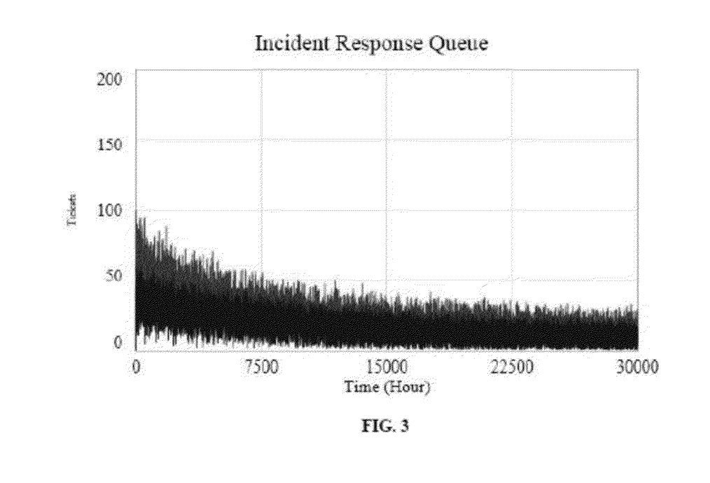

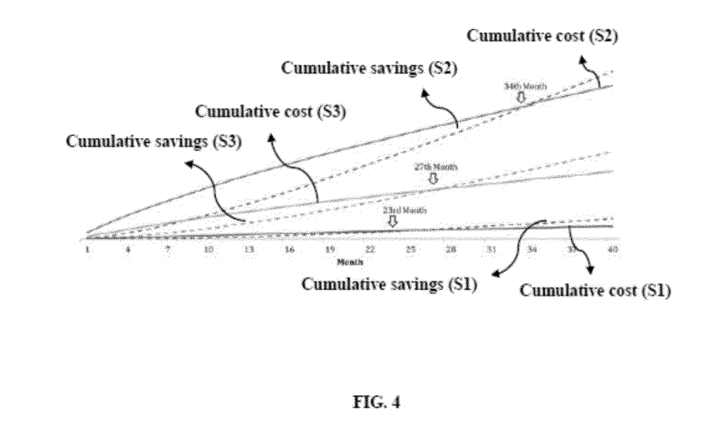

In one implementation, at first, a user may use the client device 104 to access the system 102 via the I/O interface 204. The working of the system 102 may be explained in detail using FIG. 2, FIG. 3 and FIG. 4 explained below. The system 102 may be used for obtaining optimal pricing strategy in a service engagement.

In order to obtain an optimal pricing strategy in a service engagement, at first, the system 102 may create a model. The model may represent the service engagement between a client and a vendor. In other words, the model may indicate identifying a plurality of components that constitute a state of the service engagement. The vendor may indicate a service provider to the client i.e., an organization. The client may employ the vendor to achieve objectives of the client. The client may employ the vendor based on an agreement negotiated with the vendor. The service engagement may indicate an arrangement made between the client and the vendor such that the vendor delivers certain services to achieve objectives of the client. In one example, the service engagement may include the vendor providing services to the client to build a data center at a facility of the client. In another example, the service engagement may include the vendor providing services to a product of the client for a certain period of time e.g. monthly, quarterly, yearly, and the like.

The model may comprise the plurality of components that are identified to execute the service engagement. For example, the plurality of components may comprise a service desk and support teams in one or more levels. In another example, service engagement may comprise service operation processes. The service operation processes may comprise at least one of an event management, a request fulfillment, an incident management, a problem management, and an access management.

The event management may indicate a process of analyzing, and planning to execute the objectives of the client by the vendor. For example, the vendor may analyze and plan number of resources required for executing a project for the client in a year. The request fulfillment may indicate information provided by the vendor to the client based on a request raised by the client. In one example, the client may raise a request in a form of a ticket. The ticket may indicate a task that the client requests the vendor to fulfil. In one example, the ticket may include the request to install/upgrade an application in a database of the client. Based on the request, the vendor may install/upgrade the application in the database of the client. The incident management may indicate response time taken by the vendor to resolve an issue of the client. In one example, consider a break down in a network of the client to access the database. The client may request the vendor to check an error to fix the network. The amount of time the vendor takes to fix the network e.g. one hour may be considered for the incident management.

The problem management may indicate managing problems that occur during tenure of the service engagement. In one example, measures taken by the vendor to prevent the problems from occurring. For example, the measures taken by the vendor to prevent break down in the network may be considered as the problem management. In another example, the measures taken by the vendor to eliminate recurring incidents and to minimize the impact of incidents that cannot be prevented may be considered as the problem management. The access management may be indicative of controlling access to view the information of the client for personnel at an organization of the vendor or client. For example, the vendor may grant access to the data of the client to the personnel who have authority in the organization. Similarly, the vendor may restrict or deny access to the data of the client to the personnel having no authority in the organization.

In one implementation, the service engagement may comprise all of the service operation processes discussed above. In one implementation, the service engagement may comprise a subset of the service operation processes. The subset may indicate a short term SLA required to be executed by the vendor.

In one example, the model may comprise one or more characteristics of the service engagement. Each characteristic in the model may be represented by multiple entities. In one implementation, the characteristics may comprise roles and responsibilities definition indicating support levels to resolve the tickets, Service Level Agreement (SLA), Key Performance Indicator (KPI) definition, and knowledge management, etc.

The model may be created based upon contextual variables and objectives. In one implementation, the model may be created using a plurality of pre-defined templates. A pre-defined template may indicate a model that is built based on a scenario corresponding to the contextual variables and the objectives. If the model to be created is similar to any of the scenarios built earlier, at least one template may be selected from the plurality of pre-defined templates based upon the contextual variables and the objectives corresponding to the scenario. Further, if the scenario is not available i.e., when the plurality of pre-defined templates are not available, the model may be created based on the contextual variables and the objectives.

The contextual variables may indicate changeable parameters in the model that represent a context or facts of the service engagement. Based on the context or the facts of the service engagement, the contextual variables may be categorized. In one example, the contextual variables may be categorized based on characteristics and relation to the service engagement. The contextual variables may comprise attributes of the service engagement. The engagement may further comprise one or more applications. The application may further be characterized by problem proneness. The contextual variables based on the attributes of the service engagement indicate factors that define the service engagement. In one example, the contextual variables based on the attributes of the service engagement comprising the tenure of the service engagement, location to execute the service engagement and cost of resources to meet the service engagement. The application may indicate severity or distribution of the tasks based on the service engagement among the plurality of components. In one example, the application may comprise criticality of the application, distribution of priorities among the plurality of components and volume of the tickets during the service engagement. The problem proneness may indicate occurrence of a problem based on factors that are not defined during the service engagement. In one example, the problem proneness comprises at least one of uncertainty in the service engagement, frequency of recurrence of the problems and ticket-to-problem ratio.

The objectives of the service engagement may indicate expected results by the client to obtain the optimal pricing strategy. In one implementation, the objectives may be defined by the client. The objectives of the service engagement may include at least one of reduction in cost, efficiency, throughput and availability of the resources. The efficiency may be indicative of throughput achieved during the service engagement. The availability of resources may indicate resolving the problems in lesser time and complying with Service Level Agreements (SLA) as per the service engagement.

In order to understand creating a model, consider an example of the vendor providing support to a client. The vendor may provide support to the client by providing services through a number of configuration items. The configuration items may indicate a requirement of the client that is to be supported by the vendor. In one example, the configuration items comprise at least one of applications, network components, database servers, mainframes, etc. In order to provide the services to the client, the vendor may form a group comprising personnel. The group may be formed based on functions to be executed as per the service engagement between the client and the vendor. The functions may be executed by supporting the configuration items in the service delivery processes by the vendor. In one example, the service delivery processes comprise at least one of the incident management, the problem management, the change management, the event management, etc. Based on the resources available such as the personnel, the configuration items and the service delivery processes, the model may be created. The model may be created by defining the plurality of components required to execute the service engagement.

After creating the model, a pricing strategy may be selected. The pricing strategy may be selected based on a capacity model of the vendor. In order to determine the capacity model of the vendor, distribution of the tickets and distribution of work for the configuration items may be considered. In one example, the configuration items may comprise constraints in competency, support required during the service engagement and constraints during service to determine the capacity model. In one example, the capacity model may comprise attributes such as Full-Time Equivalent (FTE) requirements, location and distribution of the personnel as per shifts. In order to determine the capacity model, costs associated with the FTE requirements and fixed cost per FTE for the distribution of the personnel may be considered. Further, cost for each ticket may be determined and a margin that is to be kept may be defined. In one implementation, the cost for each ticket may be determined based on the configuration items and the distribution of the tickets. After determining the cost of each ticket, cost per FTE and fixed cost per FTE, a total cost for the capacity model may be obtained. Subsequently, the total cost for the capacity model may be given as an input to determine the pricing strategy.

The pricing strategy may be selected from one of a fixed strategy, a variable strategy and a combination thereof. In the fixed strategy, fixed volume of the tickets and total costs for the capacity model are considered for the configuration items in the service engagement. In the variable strategy, as volume of the tickets is not assured, the pricing may be calculated based on the resources available and volume of the tickets expected. The volume of the tickets expected may be determined based on the cost per resource that is available and cost per an additional resource that is to be added to execute the service engagement. In the combination of fixed and variable strategy, cost per ticket for each of the configuration item and procurement cost of the additional resource may be determined. For determining the procurement cost, specific variable cost per ticket may be considered for the configuration item wherein the cost varies based on volume of the tickets. In one implementation, the fixed strategy may be selected if volume of the tickets and total costs for the tickets to be used are known. In one implementation, the variable strategy may be used if the volume of the tickets are known and cost for the tickets are unknown or vice versa. In one implementation, the combination of the fixed and variable strategy may be used when the cost for the ticket is known and procurement cost of the additional resources to be used for the tickets is not known.

After selecting the pricing strategy, a client payoff associated with the client and a vendor payoff associated with the vendor may be computed. The client payoff and the vendor payoff may be computed based on the pricing strategy, and the contextual variables. The vendor payoff may indicate a utility the vendor obtains from the service engagement. Similarly, the client payoff may indicate the utility the client obtains from the service engagement. The vendor payoff may be computed by calculating a difference between costs of the vendor and fees of the vendor. In other words, the vendor payoff indicates a value the vendor obtains for the cost that is required to execute the service engagement. The fees of vendor are price which the client pays to the vendor for the service engagement. The costs of the vendor indicate the price which the vendor incurred to execute the service engagement. In one implementation, for the production support engagements, the vendor payoff may be agreed based on the objectives of the service engagement. In one implementation, the objectives of the service engagement may be modified to increase the efficiency during the tenure of the service engagement. The objectives may be translated into the constraints to compute the vendor payoff.

As disclosed above, the vendor payoff may be calculated by differencing the fees of the vendor and the costs of the vendor. The fee of the vendor may be calculated using pricing points, price per unit and a functional dependency factor. The functional dependency factor indicates a function connecting the pricing points/units of work (UoW) and the price per unit. The fee of the vendor and the vendor payoff may be computed as:

Fee of the vendor=Base Capacity+f(UoW,Price per Unit)

Vendor payoff=Fee of the vendor−costs of the vendor

In one implementation, the vendor fees may be computed for fixed pricing strategy. In the fixed pricing strategy, the fees of the vendor may be specified at the time of the service engagement. For example, the service engagement may be specified as—for a period of one year, the vendor may execute the SLA at a particular cost. In another implementation, the fees of vendor may be computed for variable pricing strategy. In the variable pricing strategy, price per unit may vary for pricing points. In the variable pricing strategy, the pricing points may have a different price for units and the cost may be computed separately and the fees of the vendor may be determined. Based on the pricing strategy selected, the vendor fee may be determined. Subsequently, the costs for the vendor may be obtained as specified above. Based on the vendor fee and costs, the vendor payoff may be computed. The vendor payoff may be computed by differencing the fees of the vendor and the costs of the vendor.

Based on the vendor fee, the client payoff may be computed. The client payoff may indicate the utility that the client obtains from the service engagement. The client payoff may be computed by differencing a utility the client derives from the service engagement and the fees of the vendor. The utility may indicate the functional dependency factor comprising at least one of variables comprising frequency of incidents, average resolution time, and other variables. In one example, the utility that the client obtains may include number of incidents solved by the vendor in a particular time and the costs associated with the vendor to solve the incidents. In another example, the utility that the client obtains may include number of service disruptions occurred in a particular time and the time the client takes to respond to the service disruptions. In other words, the client payoff may be calculated by considering an incident inflow and an average resolution time. In one example, the client payoff may be calculated based on function of incident frequency, average resolution time and fee of the vendor. The client payoff may be calculated as:

Payoff of the client=f(Incident Frequency,Average Resolution Time)−fee of the vendor

After computing the client payoff and the vendor payoff, the model may be simulated for a pre-defined interval i.e., the tenure of the service engagement. For example, if the predefined time interval is of one year, there will be twelve instances, wherein each instance indicates a month in that particular year. The vendor payoff may be determined for each instance in the pre-defined interval. Similarly, the client payoff may be computed at each instance of the pre-defined time interval. From the simulation, a time series data may be obtained for the predefined time interval. The time series data may indicate behaviour of the model with respect to the vendor payoff and the client payoff.

Subsequent to obtaining the time series data with respect to the vendor payoff and the client payoff, an optimizer payoff function may be calculated. The optimizer payoff function may indicate the vendor payoff and the client payoff for which the vendor and the client obtain a value from the service engagement. In other words, the optimizer payoff function may indicate the value or the outcome the vendor and the client obtains based on the objectives. In order to obtain the value that is constructive for the vendor and the client, relative weights may be assigned to the vendor payoff and the client payoff. The relative weights are assigned for the vendor payoff and the client payoff to determine the value that the vendor or the client obtains for the service engagement.

In order to increase the value of the service engagement for the vendor and the client, it may be required to increase the vendor payoff and the client payoff respectively. In order to increase the value, the relative weights are assigned to at least one of the vendor payoff and client payoff. For example, the vendor payoff may be given more relative weight as compared to the client payoff to obtain maximum vendor payoff. Similarly, the client payoff may be given more relative weight as compared to the vendor payoff to obtain maximum client payoff. In another example, the vendor payoff and the client payoff may be given optimal relative weights to obtain maximum vendor payoff and the client payoff respectively. For obtaining the optimal pricing strategy, the optimizer payoff function may be modified/altered iteratively by changing the pricing strategy selected and the contextual variables based on the objectives.

In order to explain obtaining of the optimal pricing strategy, an example may be used. Consider, for a model, the pricing strategy selected is the variable strategy. For the variable strategy, consider pricing points comprise incidents solved and resolved errors. For the variable strategy, consider the contextual variables comprises the predefined time interval i.e., tenure of the service engagement, criticality of the service engagement, frequency of ticket recurrence, volume of the tickets, cost of the resources, ticket to problem ratio, uncertainty in the volume of the tickets. For the contextual variables, initial values may be defined. Table 1 may be used as an example to explain the initial values defined for the contextual variables.

TABLE 1
Initial values defined for the contextual variables

| Variable | Initial Value |
|---|---|
| Tenure of engagement | Maximum of 40 months |
| Business criticality | Medium |
| (configuration items) | |
| Frequency of ticket | Follows (1—diminishing marginal utility curve). |
| recurrence | Rate is dependent on context of the engagement |
| Location (Centralized, | Centralized |
| Distributed) | |
| Volume of tickets | Dependent on the context |
| Application maturity | |
| Resource costs (High/ | |
| Low) | |
| Ticket to problem | |
| ratio | |
| Uncertainty in ticket | |
| volume | |

Based on the contextual variables, the model may be created. The model may be selected from the plurality of pre-defined templates as described above. Considering that the variable pricing strategy is selected for the model, at first, the vendor fee may be computed. For example, the vendor fee may be computed for three scenarios such as incidents resolved, problems corrected and resources deployed. Based on the scenarios, the vendor fee may be computed as—

Vendor Fee₁=UoW1*p1+UoW2*p2

Vendor Fee₂=UoW1*p1+UoW3*p3

Vendor Fee₃=UoW3*p3

For the above example, consider, price per unit for the incidents resolved is $1. The vendor fee may be computed as—

Vendor's Fee₁=$1*Incidents Resolved

Similarly, consider the price per unit for the problems corrected is $100. The vendor fee may be computed as—

Vendor's Fee2=$100*Problems Corrected

Similarly, consider the price per unit for the resources deployed by the vendor for an hour is $100. The vendor fee may be computed as—

Vendor's Fee3=$20*Resources Deployed*Hours

The UoW indicate the pricing points and the p indicate the price per unit. In one implementation, the vendor fee may be computed for the fixed pricing strategy. If the fixed pricing strategy is selected, the vendor fee may be computed based on the fixed costs for the UoW.

After computing the vendor fee, the vendor payoff may be computed. The vendor payoff may be computed by differencing the costs from the vendor fee. Based on the vendor fee, the client payoff may be computed. The client payoff may be calculated based on function of incident frequency, average resolution time and fee of the vendor. In one example, consider, the function of average incident resolution time is 1 and the function of the incident occurrence is 2. The client payoff for the above example may be computed as:

Client payoff=((1/Average Incident Resolution Time)+(2.5/Incident Occurrence)−Vendor Fee

In order to increase the client payoff and the vendor payoff, the optimizer payoff function may be calculated. The optimizer payoff function may be calculated by assigning the relative weights to the client payoff and the vendor payoff. For example, consider, the relative weights assigned to the client payoff and the vendor payoff is X1 and X2 respectively. The values assigned for X1 and X2 are 2 and 3 respectively. Considering the relative weights assigned, the optimizer payoff function may be calculated as—

Optimizer payoff function=(X1*Payoff Client+X2*Payoff Vendor)/(X1+X2),

wherein the X1 and X2 are 2 and 3 respectively.

In order to obtain the optimal pricing strategy, the pricing strategy selected may be modified/altered such that the vendor fee is modified to compute the client payoff and the vendor payoff. Based on the pricing strategy selected, the optimizer payoff function may vary as the vendor fee varies. To optimize the optimizer payoff function, the pricing strategy may be modified/altered iteratively based on the objectives. Based on the optimizer payoff function obtained after modification, the optimizer payoff function that provides an optimal client payoff and the vendor payoff may be selected to execute the service engagement.

In one embodiment, considering the contextual variables, an investment analysis for the client may be determined. For the context variables considered in the model as shown in Table 1, minimum tenure of the service engagement required to meet a break even condition by the client may be determined.

For the client, the problem management may be viewed as an investment that helps to reduce the incident inflow over time. Further, it may be imperative for the client that the costs incurred by having the problem management should at least be offset by savings obtained from the incident management. For analyzing feasibility of the investment in the problem management with respect to the tenure of engagement, three scenarios may exist. In order to illustrate the scenarios, Table 2 may be used as an example.

TABLE 2
Scenarios in the problem management

| Variable | Scenario 1 | Scenario 2 | Scenario 3 |
|---|---|---|---|
| Problem to Ticket ratio | Low | High | Medium |
| Uncertainty in ticket volume | Low | High | Medium |
| Resource Costs | Low | High | Medium |
| Initial Application Maturity | Low | Medium | High |
| Tickets Inflow | Low | High | Medium |

For the scenarios considered, in order to determine the break even condition for the client, a simulation may be run based on the contextual variables and the utility of the client. From the simulation, a time series data indicating the costs incurred the due to the incident management and problem management may be obtained. During the tenure of the service engagement, the incident inflow i.e., time taken to resolve the tickets such as the problem management reduces. Referring to FIG. 3, the reduction in the incident response time for the problem management is illustrated using an example. From the FIG. 3, consider the incident inflow for the number of tickets that present after 7500 hours of ticket inflow. It may be noted from the FIG. 3 that the incident response time for the problem management is reducing as the tenure of the service engagement progress. Corresponding to the reduction in cost of the incident management, the costs associated with the problem management may be compared. Table 3 and Table 4 may be used as an example to illustrate the costs associated with the problem management and savings achieved for the scenarios presented in Table 2 during the tenure of the service engagement.

TABLE 3
Table 3: Costs associated with the problem management

| | Scenario 2 | | Scenario 3 | | Scenario 1 | |
|---|---|---|---|---|---|---|
| | | Cumulative | Cumulative | Cumulative | Cunulative | Cumulative |
| | Cumulative | IM Savings | PM Cost | IM | PM Cost | IM |
| Month | PM Cost R2 | R2 | R3 | Savings | R1 | Savings |
| 1 | 37340.16418 | 5798.950722 | 14265.09 | 1570.6138 | 0 | 1194.166 |
| 2 | 71440.56702 | 12593.85124 | 28200.362 | 4545.2763 | 2240 | 1296.5464 |
| 3 | 104300.1099 | 22123.03115 | 41595.663 | 8697.6655 | 4610.01 | 918.26184 |
| 4 | 135979.2633 | 34889.20279 | 54720.354 | 13952.252 | 6980.05 | 207.73466 |
| 5 | 165197.6166 | 48604.56268 | 67199.324 | 19974.716 | 9270.1 | 1136.91 |
| 6 | 193856.0944 | 64041.81927 | 79348.28 | 26915.572 | 11560.15 | 1856.6893 |
| 7 | 221254.5624 | 81626.79183 | 91497.225 | 34139.539 | 13860.2 | 2731.0301 |
| 8 | 247553.3142 | 100163.431 | 103272.33 | 42972.579 | 16050.25 | 3872.3017 |
| 9 | 272812.6221 | 118734.9031 | 114388.29 | 51120.522 | 18250.3 | 5216.1908 |
| 10 | 298112.2742 | 139669.7924 | 125789.03 | 60337.932 | 20380.35 | 7076.0348 |
| 11 | 322091.3086 | 160658.3834 | 136979.87 | 70386.424 | 22560.4 | 8884.9374 |
| 12 | 345750.5188 | 182026.6805 | 147450.85 | 80589.514 | 24650.45 | 10637.761 |
| 13 | 369069.9158 | 204468.9535 | 158086.75 | 91384.443 | 26720.5 | 12999.939 |
| 14 | 391628.6926 | 227469.7992 | 168602.77 | 103130.44 | 28870.55 | 15549.223 |
| 15 | 413927.3987 | 251338.7995 | 178698.73 | 115071.75 | 30860.6 | 18036.517 |
| 16 | 435725.7996 | 276119.7343 | 188614.79 | 128007.86 | 32790.5 | 20883.227 |
| 17 | 456803.8635 | 301588.1024 | 198123.12 | 141172.92 | 34610.2 | 23792.692 |
| 18 | 477502.2278 | 326959.9434 | 207615.01 | 154691.21 | 36519.9 | 26980.501 |
| 19 | 498260.1318 | 353476.5455 | 216911.54 | 168133.25 | 38409.55 | 29544.754 |
| 20 | 518198.9746 | 380012.8702 | 226268.3 | 182013.97 | 40239.25 | 32985.074 |

TABLE 4
Table 4: Costs associated with the problem management

| | Scenario 2 | | Scenario 3 | | Scenario 1 | |
|---|---|---|---|---|---|---|
| | Cumulative | Cumulative | Cumulative | Cumulative | Cunulative | Cumulative |
| | PM Cost | IM | PM Cost | IM | PM Cost | IM |
| Month | R2 | Savings | R3 | Savings | R1 | Savings |
| 21 | 537961.06 | 407157.14 | 235445.18 | 196478.23 | 41949 | 36083.782 |
| 22 | 557423.4 | 435220.2 | 244426.9 | 210619.16 | 43818.7 | 39334.922 |
| 23 | 576166.75 | 462625.96 | 253633.39 | 225775.14 | 45628.4 | 42625.394 |
| 24 | 595409.24 | 490090.25 | 262180.11 | 240575.62 | 47438.1 | 46258.113 |
| 25 | 614691.71 | 517933.2 | 270966.77 | 256082.51 | 49207.8 | 49903.064 |
| 26 | 633695.01 | 545657.13 | 279348.47 | 271807.97 | 50977.5 | 53472.981 |
| 27 | 652738.16 | 574421.44 | 287610.12 | 287601.3 | 52657 | 57373.148 |
| 28 | 671001.59 | 603141.76 | 295961.72 | 303605.34 | 54317 | 61372.86 |
| 29 | 689264.89 | 631803.09 | 304058.28 | 319659.67 | 55956.5 | 65282.79 |
| 30 | 707469.6 | 660945.87 | 312319.75 | 336265.53 | 57556.5 | 69697.081 |
| 31 | 725613.4 | 690663.83 | 320221.44 | 352790.49 | 59206 | 73879.084 |
| 32 | 743437.32 | 720736.11 | 327973.14 | 369523.45 | 60696 | 78187.822 |
| 33 | 760621.28 | 750378.73 | 335739.9 | 386026.83 | 62315.5 | 82687.876 |
| 34 | 778145.75 | 780729.35 | 343761.57 | 402922.42 | 63915.5 | 86878.486 |
| 35 | 795630.19 | 810321.09 | 351468.27 | 419790.55 | 65415.5 | 91545.315 |
| 36 | 813234.38 | 840397.89 | 359115.01 | 436348.46 | 66866 | 96060.834 |
| 37 | 830659.12 | 870863.98 | 367061.76 | 453743.88 | 68416.5 | 100748.98 |
| 38 | 847924.26 | 901395.97 | 374303.49 | 471057.78 | 69896.5 | 104963.23 |
| 39 | 864769.59 | 932210.56 | 381815.07 | 488337.81 | 71367 | 109760.52 |
| 40 | 881475.52 | 962833.84 | 389332.95 | 505929.16 | 72657 | 117039.82 |

The costs incurred and savings achieved may be simulated for the predefined time interval i.e., 40 months. The times series data obtained based on the simulation may be illustrated using FIG. 4. Specifically, FIG. 4 shows the costs and the savings incurred in cumulative for the scenarios presented above. From the FIG. 4, it may be noted that the scenario comprising high ticket inflow has the break even condition earlier as compared to other scenarios. From the FIG. 4, it may be noted that the scenario 2 comprises the break even condition at the 34^{th} month of the tenure of the service engagement. Similarly, for the scenario 3 and the scenario 1, the break even condition is achieved at 27^{th} and 23^{rd} month respectively. The savings may be computed by the model by comparing with the number of problem management. Based on the tenure of an engagement and the breakeven condition, a user may decide if the problem management is optimal or not. If the breakeven condition achieved is not optimal, the user may include resolved errors to re-compute the break even condition.

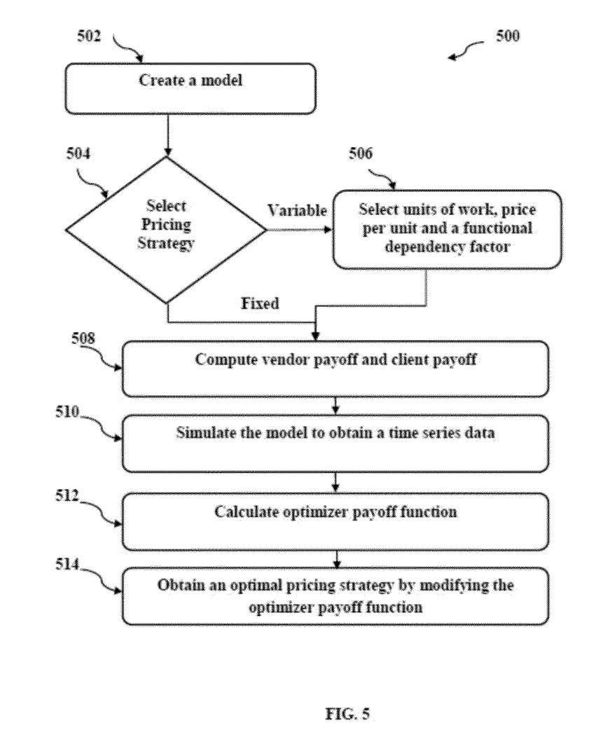

Referring now to FIG. 5, a method 500 for obtaining optimal pricing strategy in a service engagement is shown, in accordance with an embodiment of the present disclosure. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described and is not intended to be construed as a limitation, and any number of the described method blocks can be combined in any order to implement the method 500 or alternate methods. Additionally, individual blocks may be deleted from the method 500 without departing from the spirit and scope of the disclosure described herein. Furthermore, the method may be implemented in any suitable hardware, software, firmware, or combination thereof. However, for ease of explanation, in the embodiments described below, the method 500 may be implemented in the above-described system 102.

At step/block 502, a model may be created for a service engagement between a client and vendor. The model may be created based on at least one template selected from a plurality of pre-defined templates. The at least one template is selected based upon contextual variables and objectives associated with the model.

At decision step/block 504, a pricing strategy may be selected for the service engagement based on the contextual variables and the objectives. The pricing strategy may be selected from one of a fixed strategy, a variable strategy and a combination thereof. If the variable strategy is selected, pricing points, price per unit and a functional dependency factor may be considered as shown at step/block 506.

At step/block 508, a vendor payoff associated with the vendor and a plurality of client payoffs associated with the client may be computed. The vendor payoff and the client payoff may be calculated based on the pricing strategy selected for the model.

At step 510, the model is simulated for a predefined time interval to obtain a time series data. The time series data indicates behaviour of the model.

At step 512, an optimizer payoff function is calculated. The optimizer payoff function is calculated by assigning relative weights to the client payoff and the vendor payoff.

At step 514, the optimizer payoff function may be modified/altered to obtain an optimal pricing strategy by changing the pricing strategy.

Although implementations of system and method for obtaining an optimal pricing strategy in a service engagement have been described in language specific to structural features and/or methods, it is to be understood that the appended claims are not necessarily limited to the specific features or methods described. Rather, the specific features and methods are disclosed as examples of implementations for obtaining an optimal pricing strategy.

We claim:

1. A computer implemented method for obtaining an optimal pricing strategy in a service engagement, the method comprising:
creating a model for a service engagement between a client and a vendor, wherein the model is created based on a template selected from a plurality of pre-defined templates, wherein the template is selected based upon a structure of the service engagement comprising contextual variables and objectives associated with the model;
selecting a pricing strategy for the service engagement based on the contextual variables and the objectives, wherein the pricing strategy is selected from one of a fixed strategy, a variable strategy and a combination thereof;
computing, by a processor, a vendor payoff associated with the vendor and a client payoff associated with the client, based on the pricing strategy selected for the model;
simulating the model, by the processor, for a predefined time interval to obtain a time series data, wherein the time series data is indicative of behaviour of the model with respect to the client payoff and the vendor payoff; and
obtaining, by the processor, an optimal pricing strategy for the client and the vendor based on the time series data, wherein the optimal pricing strategy is obtained by calculating an optimizer payoff function, wherein the optimizer payoff function is calculated by assigning relative weights to the client payoff and the vendor payoff, and wherein the optimal pricing strategy is obtained by altering the selection of the pricing strategy to maximize the optimizer payoff function.

2. The method of claim 1, wherein the contextual variables comprises attributes of the service engagement, wherein the attributes of the service engagement comprises one or more applications, wherein an application is characterized by problem proneness, wherein the attributes of the service engagement comprises tenure of the service engagement, a location and costs of resources, wherein the application comprises criticality of the application, distribution of tickets based on priority and volume of the tickets, and wherein the problem comprises uncertainty of the problems, frequency of ticket reoccurrence, and ticket to problem ratio.

3. The method of claim 1, wherein the service engagement indicates an engagement in a production support comprising an event management, a request fulfillment, an incident management, a problem management, and an access management.

4. The method of claim 1, wherein the variable strategy comprises determining pricing points, price per unit and a functional dependency factor, wherein the functional dependency factor indicates a function connecting the pricing points and the price per unit for the variable pricing strategy.

5. The method of claim 1, wherein the objectives comprises at least one of: cost reduction, efficiency, throughput and availability.

6. The method of claim 1, wherein the vendor payoff is computed by differencing cost to the vendor from fees of the vendor.

7. The method of claim 6, wherein the fees of the vendor is computed using capacity of the vendor and the pricing points, price per unit and the functional dependency factor.

8. The method of claim 1, wherein the client payoff is computed by differencing a utility the client derives from the service engagement and the fees of the vendor, wherein the utility indicates the functional dependency factor comprising at least one of variables comprising frequency of incidents, average resolution time, and other variables thereof.

9. A system for obtaining an optimal pricing strategy in a service engagement, the system comprising:
a processor; and
a memory coupled to the processor, wherein the processor executes program instructions stored in the memory, to:
create a model for a service engagement between a client and a vendor, wherein the model is created based on a template selected from a plurality of pre-defined templates, wherein the template is selected based upon a structure of the service engagement comprising contextual variables and objectives associated with the model;
select a pricing strategy for the service engagement based on the contextual variables and the objectives, wherein the pricing strategy is selected from one of a fixed strategy, a variable strategy and a combination thereof;
compute a client payoff associated with the client and a vendor payoff associated with the vendor, based on the pricing strategy selected for the model;
simulate the model for a predefined time interval to obtain a time series data, wherein the time series data is indicative of behaviour of the model with respect to the client payoff and the vendor payoff; and
obtain an optimal pricing strategy for the client and the vendor based on the time series data, wherein the optimal pricing strategy is obtained by calculating an optimizer payoff function, wherein the optimizer payoff function is calculated by assigning relative weights to the client payoff and the vendor payoff, and wherein the optimal pricing strategy is obtained by altering the selection of the pricing strategy to maximize the optimizer payoff function.

10. A non-transitory computer readable medium embodying a program executable in a computing device for obtaining an optimal pricing strategy in a service engagement, the program comprising:
a program code for creating a model for a service engagement between a client and a vendor, wherein the model is created based on a template selected from a plurality of pre-defined templates, wherein the template is selected based upon a structure of the service engagement comprising contextual variables and objectives associated with the model;
a program code for selecting a pricing strategy for the service engagement based on the contextual variables and the objectives, wherein the pricing strategy is selected from one of a fixed strategy, a variable strategy and a combination thereof;
a program code for computing a vendor payoff associated with the vendor and a client payoff associated with the client, based on the pricing strategy selected for the model;
a program code for simulating the model for a predefined time interval to obtain a time series data, wherein the time series data is indicative of behaviour of the model with respect to the client payoff and the vendor payoff; and
a program code for obtaining an optimal pricing strategy for the client and the vendor based on the time series data, wherein the optimal pricing strategy is obtained by calculating an optimizer payoff function, wherein the optimizer payoff function is calculated by assigning relative weights to the client payoff and the vendor payoff, and wherein the optimal pricing strategy is obtained by altering the selection of the pricing strategy to maximize the optimizer payoff function.
